(19) United States
(12) Patent Application Publication
(10) Pub. No.: US 2008/0141867 A1
(43) Pub. Date: Jun. 19, 2008

(54) INTELLIGENT USER INTERFACE FOR MULTI-PURPOSE OVEN USING INFRARED HEATING FOR REDUCED COOKING TIME

(75) Inventors: Luis Cavada, Miami, FL (US); Alvaro Vallejo-Noriega, St. Joseph, MI (US); Victoria Vilbrandt, Hollywood, FL (US)

Correspondence Address: BAKER BOTTS L.L.P.;PATENT DEPARTMENT, 98 SAN JACINTO BLVD., SUITE 1500, AUSTIN, TX, 78701-4039, US

(73) Assignee: Applica Consumer Products, Inc.

(21) Appl. No.: 11/926,333

(22) Filed: Oct. 29, 2007

Related U.S. Application Data
(63) Continuation-in-part of application No. 11/319,050, filed on Dec. 27, 2005.
Application No. 11/319,050 is a continuation-in-part of application No. 10/776,028, filed on Feb. 10, 2004, now Pat. No. 7,323,663.
Application No. 10/776,028 is a continuation-in-part of application No. 10/815,098, filed on Mar. 31, 2004, now abandoned.

(51) Int. Cl. A47J 37/06; A21B 1/00; A21B 1/22; F27D 11/00

(52) U.S. Cl. 99/332; 219/411

(57) ABSTRACT

An intelligent user interface for the selection of predefined cooking profiles for a number of different foods to be cooked in a multi-purpose oven using infrared heating. When a food has not been predefined for cooking in the infrared multi-purpose oven, procedures used for conventional cooking technologies may converted to for use by the multi-purpose oven so as to obtain substantially the same cooking results for the desired food. The intelligent user interface may have menus of different foods for programming cooking profiles for the infrared multi-purpose oven. Predefined “hot buttons” may be used for quick selection of a cooking profile for a desired food (e.g., common foods such as popcorn, pizza rolls, chicken wings, oven fries, and other prepared and frozen foods), and/or a menu screen may be scrolled through to select a cooking profile for the desired food.

### RELATED PATENT APPLICATIONS

This patent application is a continuation-in-part application of and claims priority to commonly owned U.S. patent application Ser. No. 10/776,028, filed Feb. 10, 2004, entitled “Multi-Purpose Oven Using Infrared Heating For Reduced Cooking Time” by Luis Cavada and Alvaro Vallejo; and U.S. patent application Ser. No. 10/815,098, filed Mar. 31, 2004, entitled “Intelligent User Interface for New Cooking Technologies” by Luis Cavada, Alvaro Vallejo and Victoria Vilbrandt; wherein the aforementioned patent applications are hereby incorporated by reference herein for all purposes.

### TECHNICAL FIELD

The present disclosure relates to selecting cooking parameters in the preparation of foods, and more specifically, selecting cooking parameters using an intelligent user interface to select the cooking parameters of a multi-purpose oven using infrared heating in the preparation of the foods.

### BACKGROUND

Over the years there have been many attempts to introduce new cooking technologies that would allow faster cooking of foods. Products such as convection, microwave, and infrared ovens have been devised in order to try and speed up the cooking process. However the new cooking technologies caused consumers to guess how to properly cook foods, e.g., time, power used, etc. Guidelines were presented as to how to best cook using a new technology, but required much trial and error before satisfactory cooking results were obtained. Quite often the user was frustrated and took a long time to arrive at reasonable results.

With subsequent technology enhancements in the new cooking technology products, e.g., microwave ovens, these products began to include some pre-programmed functions, e.g., buttons for cooking popcorn, baked potatoes, and frozen foods. Unfortunately, these pre-programmed functions still fell short in meeting the user's expectations. With differing amounts of food to be cooked, these pre-programmed functions proved inadequate for all situations. Yet other new technologies provided a complex interface where the user was required to reply to multiple questions in order to approximate a cooking cycle. The resulting cooking cycle would be adjusted for the amount of food to be cooked. This was particularly important since the new cooking technologies were not able to cook varying amounts of food in the same time frame.

### SUMMARY

Therefore a problem exists and a solution is needed for better and more consistent results when cooking foods with cooking technologies using infrared heating.

According to a specific example embodiment of this disclosure, an intelligent user interface may be used in selecting predefined infrared cooking profiles for cooking a number of different foods. When a food has not been predefined for the infrared cooking technology, procedures used for conventional cooking technologies may be converted to the desired infrared cooking technology procedures so as to obtain substantially the same cooking results for the desired food.

According to another specific example embodiment of this disclosure, selection from a menus of a plurality of different foods may be used for programming a infrared cooking profile for the selected food to be cooked. Profile parameters for infrared cooking may be empirically determined and/or extrapolated from profile parameters determined from cooking of similar foods. Predefined “hot buttons” may be used for quick selection of an infrared cooking profile for a desired food (e.g., common foods such as popcorn, pizza rolls, chicken wings, oven fries, and other prepared and frozen foods), and/or a menu screen may be scrolled through to select an infrared cooking profile for the desired food.

According to still another specific example embodiment of this disclosure, a user may simply define an infrared cooking profile using a familiar method, e.g., from a standard cookbook and/or prior experience, e.g., old family recipe, and then this familiar cooking profile may be converted to an equivalent cooking profile appropriate for the infrared cooking technology being used. The intelligent user interface may correlate standard instructions for cooking foods, e.g., in a conventional oven, to the necessary control and timing profiles for cooking the same food using the infrared oven. When the user desires to cook a food whose cooking profile has not been correlated to infrared cooking, the user may optionally select a custom menu option, e.g., convert-menu. The convert-menu may query the user for information that may be used for converting a conventional cooking profile for a food to an equivalent operating profile for cooking the food with the infrared oven. The user may be asked to enter the type of food, e.g., meat, fish, poultry, vegetables, pastry, pies, etc., and the conventional cooking temperature and time for that food. The type of food, and the conventional cooking temperature and time may then be used for converting to an equivalent operating profile for cooking the food with the infrared oven. Weight and/or thickness of the food also may used in the profile conversion process. Thus, the conversion process may use the conventional cooking parameters and type of food, optionally including weight and/or thickness to create an appropriate infrared cooking profile for that food.

### BRIEF DESCRIPTION OF THE DRAWINGS

A more complete understanding of the present disclosure thereof may be acquired by referring to the following description taken in conjunction with the accompanying drawings wherein:

FIG. 1 is a schematic elevational front view of a multi-purpose oven using infrared heating, according to an example embodiment of this disclosure;

FIG. 2 is a schematic elevational side view of the multi-purpose oven illustrated in FIG. 1;

FIG. 3 is a schematic electrical block diagram of a multi-purpose oven having an intelligent user interface, according to an example embodiment of this disclosure;

FIG. 4 is a graph of relative radiant intensity (a.u.) plotted as a function of wavelength of representative filaments that may be used for the bottom infrared heaters, according to an example embodiment of this disclosure;

FIG. 5 is a graph of relative radiant intensity (a.u.) plotted as a function of wavelength of representative filaments that may be used for the top infrared heater, according to an example embodiment of this disclosure;

FIG. 6 is a schematic elevational view of an intelligent user interface, according to an example embodiment of this disclosure; and

FIGS. 7, 8A and 8B are tables of cooking parameters of an intelligent user interface for a multi-purpose oven using infrared heating in the preparation of foods, according to an example embodiment of this disclosure.

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims.

### DETAILED DESCRIPTION

Referring now to the drawings, the details of example embodiments are schematically illustrated. Like elements in the drawings will be represented by like numbers, and similar elements will be represented by like numbers with a different lower case letter suffix.

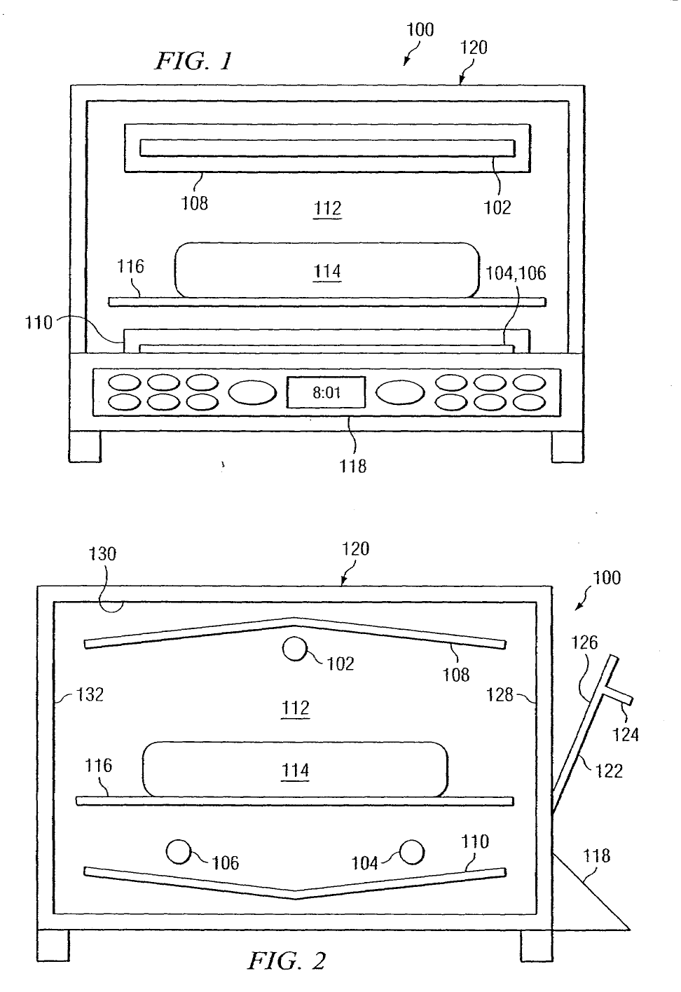

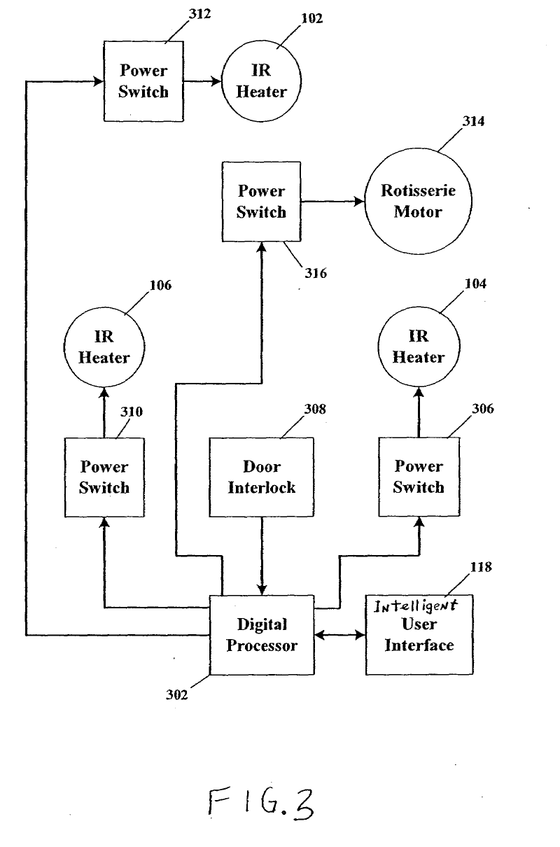

Referring now to FIGS. 1 and 2, depicted are schematic diagrams of elevational front and side views of a multi-purpose oven using infrared heating, according to an example embodiment of this disclosure. The multi-purpose oven, generally represented by the numeral 100, comprises a top infrared wavelength emitting radiant heat source (hereinafter top IR heater) 102, bottom infrared wavelength emitting radiant heat sources (hereinafter bottom IR heaters) 104 and 106, top radiant heat reflector 108, bottom radiant heat reflector 110, an oven chamber 112 adapted for cooking a food 114, food tray 116, a user interface 118, and an oven housing 120. A front door 122 (FIG. 2) is attached to the oven housing 120 and is adapted to be opened and closed, for example, by a handle 124 on the front upper portion of the door 122. The inner surfaces of the oven chamber 112, e.g., front wall 128, top wall 130, rear wall 132, interior surface of the door 122, and/or combinations thereof, may be coated with suitable material, e.g., porcelain, ceramic coatings, to re-radiate IR at a desired wavelength(s), e.g., longer or shorter IR wavelength, etc., and/or to achieve a desired operating effect, e.g., a “brick oven.”

The top IR heater 102 is positioned so as to emit infrared radiant heat directly onto the surface of the food located in the oven chamber 112. The top radiant heat reflector 108 is preferably designed to evenly distribute reflected infrared radiant heat energy over the food 114 from the top IR heater 102. The top IR heater 102 may comprise one or more infrared radiant heat sources. The top IR heater 102 may have a peak emission at, for example but not limited to, a wavelength(s) of from about 1.63 microns to about 1.7 microns (1630-1700 nm).

The bottom IR heaters 104 and 106 are located below the food tray 116. The bottom radiant heat reflector 110 directs the infrared radiant heat energy into the food 114 from the bottom IR heaters 104 and 106. The bottom IR heaters 104 and 106 preferably emit longer infrared wavelengths then does the top IR heater 102. These longer infrared wavelengths have a deeper penetration in to the food during cooking. These longer infrared wavelengths may pass through the food tray 116 and/or be reflected from the bottom radiant heat reflector 110, and/or walls of the oven enclosure 120. The bottom IR heaters 104 and 106 may have a peak emission at, for example but not limited to, a wavelength(s) of from about 2.0 microns to about 2.2 microns (2000-2200 nm). The food tray 116 may be a wire screen, heat resistant glass or ceramic, a metal pan, a grilling plate having vertical ridges thereon (not shown), etc.

Both the top IR heater 102 and bottom IR heaters 104 and 106 may also radiate some infrared energy at some percentage of infrared wavelengths that are longer and/or shorter than the aforementioned nominal infrared wavelengths. In addition to the wavelengths of the directly emitted infrared energy, the wavelengths of the reflected infrared energy may be further elongated once they have been reflected off the walls of the oven cooking chamber 120 and the reflectors 108 and 110 therein. It is contemplated and within the scope of this disclosure that radiant heaters that emit longer infrared wavelengths may be incorporated for improved cooking performance when baking and/or broiling of foods.

The reflectors 108 and 110 are shaped so as to reflect the infrared radiant heat from the top IR heater 102 and the bottom IR heaters 104 and 106, respectively, onto the food in the oven chamber 112. The infrared radiant heat reflected from the reflectors 108 and 110 may be at a longer wavelength than the directly emitted infrared radiant heat from the top IR heater 102 and the bottom IR heaters 104 and 106, respectively. This longer wavelength infrared radiant heat penetrates deeper into the food, thus shortening the moisture evaporation time of the food before surface browning may occur. The wavelengths of infrared radiated heat may be from about 1 to about 3 microns, preferably from about 1.5 to about 2.5 microns, and most preferably at about 1.63 microns for the top IR heater 102 and about 2.11 microns for the bottom IR heaters 104 and 106.

The top IR heater 102, and bottom IR heaters 104 and 106 may be comprised of a filament (not shown) whereby electrical current is passed through the filament so as to heat the filament to a temperature at which a desired wavelength(s) of infrared energy is radiated therefrom. The top IR heater 102, and bottom IR heaters 104 and 106 may radiate a plurality of wavelengths of infrared energy as well as wavelengths of visible light. Material for and electrical current through the top IR heater 102, and bottom IR heaters 104 and 106 are selected so that the heaters produce predominantly the desired infrared wavelength or wavelengths for cooking the food. The filaments may be comprised of any type of material that can be used for resistance electric heating and is capable of emitting radiant heating energy at infrared wavelengths, e.g., metal alloy filament materials such as, for example but not limited to, Ni Fe, Ni Cr, Ni Cr Fe and Fe Cr Al, where the symbols: Ni represents nickel, Fe represents iron, Cr represents chromium, and Al represents aluminum. The filaments may be exposed or, preferably, enclosed within a high temperature infrared wavelength transparent tube, such as for example, a high temperature quartz tube (not shown). The quartz tube may be clear or may have some form of coating and/or surface preparation to pass substantially only the desired infrared wavelengths, e.g., the quartz tube may be frosted, chemically etched, or have extruded grooves therein depending upon the desired infrared wavelength to be emitted therethrough. Tungsten may be used for the filament when enclosed in a sealed tube. The top IR heater 102 may consume from about 900 to 1000 watts of power, and the bottom IR heaters 104 and 106 may consume from about 500 to 600 watts of power, for a total power consumption of approximately 1500 to 1600 watts, well within the rating of a standard 20 ampere, 120 volt wall receptacle in a home or business, e.g., kitchen receptacle. It is contemplated and within the scope of this disclosure that other operating voltages and currents may be used so long as the desired infrared wavelengths of radiant heat energy are produced.

It is contemplated and within the scope of this disclosure that the aforementioned top IR heater may be located on one side of the food being cooked and/or reheated and the bottom IR heater may be located on another side of the food being cooked and/or reheated (not shown).

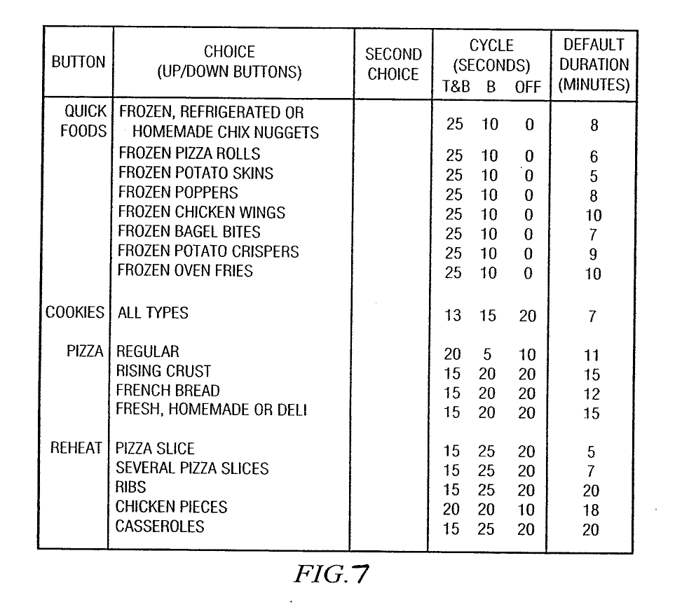

The housing 120 may be metal or non-metallic, e.g., plastic, fiberglass, etc, or some combination of both. The housing 120 is open at the front so that the food may be inserted into the oven chamber 112 when the door 122 is open. An oven control panel, e.g., intelligent user interface 118 (FIG. 6), comprises controls for the oven 100 and may be attached on or to the housing 120. A gold coating (not shown) may be applied to the quartz glass tubes for reflecting the infrared wavelength energy away from the portions of the quartz glass tubes that do not substantially contribute to the radiant heating and browning of the food. The gold coating may help in reducing the surface temperature of the housing 120. In addition, an air space between the housing 120 and the reflectors 108 and 110 also aid in reducing the surface temperature of the housing 120 during cooking and/or reheating of the food.

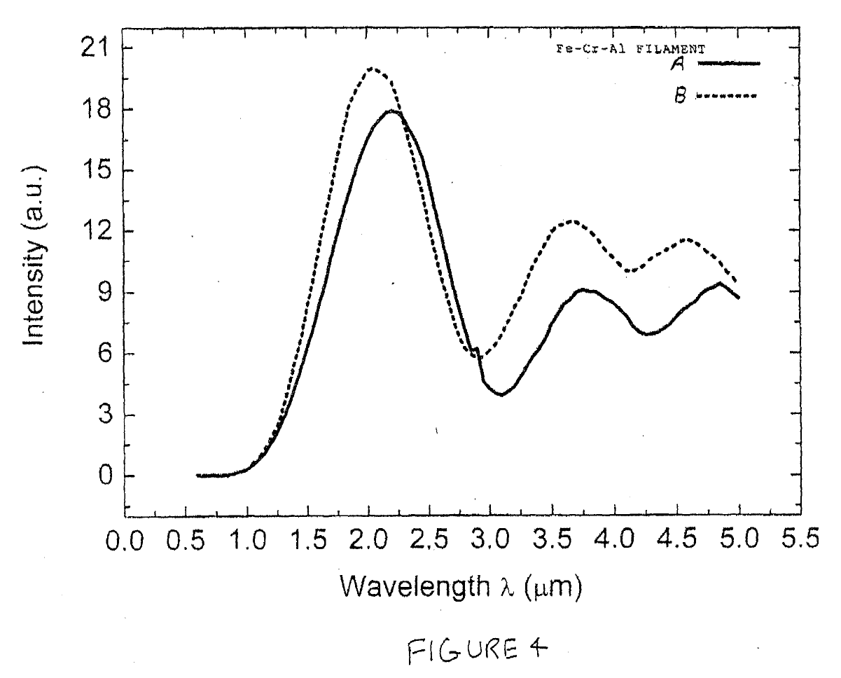

Referring now to FIG. 3, depicted is a schematic electrical block diagram of a multi-purpose infrared oven having an intelligent user interface, according to an example embodiment of this disclosure. Power may be applied to the top IR heater 102 through power switch 312, to the bottom IR heater 104 through power switch 306, and to the bottom IR heater 106 through power switch 310. The power switches 306, 310 and 312 may be controlled with a digital processor 302, e.g., microprocessor, microcontroller, application specific integrated circuit (ASIC), field programmable gate array (FPGA), etc. The digital processor 302 may receive input information from a door interlock 308, and the intelligent user interface 118. The door interlock 308 indicates when the door 122 is open and/or closed. The intelligent user interface 118 allows interaction with a user of the oven 100. The digital processor 302 may be programmed with predetermined routines for optimal cooking of various types of foods, e.g., steak, hamburger, pizza, pasta, dinner rolls, bread, toast, cookies, pies, turkey, chicken, pot roast, pork, tofu, meatloaf, vegetables, pastries, etc. The digital processor 302 may independently control each of the IR heaters 102, 104 and 106 for any combination of heating, cooking, browning, toasting, baking, broiling, defrosting, etc., desired. The digital processor 302 may also control a rotisserie motor 314 through a power switch 316. The rotisserie motor 316 may be controlled according to appropriate routines for rotisserie cooked foods.

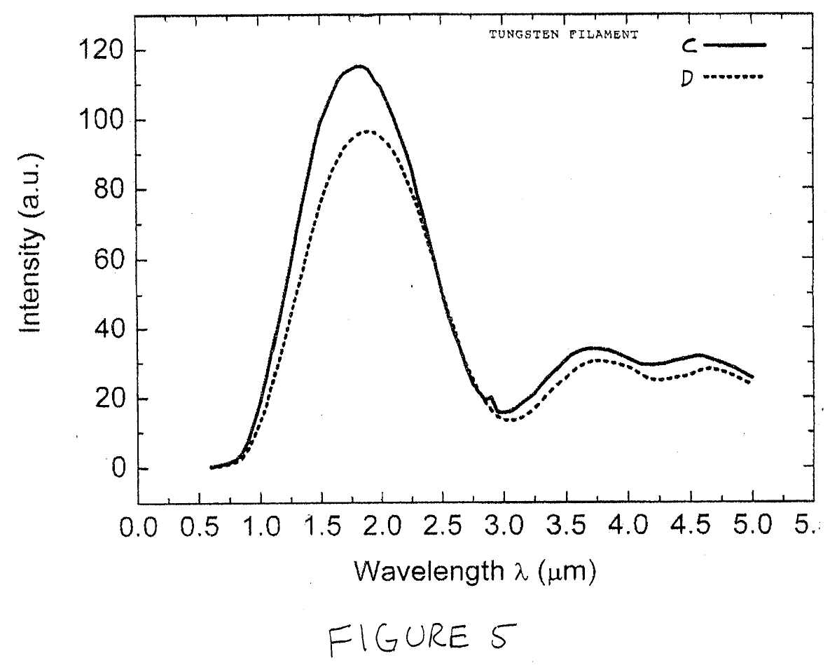

Referring to FIG. 4, depicted is a graph of relative radiant intensity (a.u.) plotted as a function of wavelength of representative filaments that may be used for the bottom infrared (IR) heaters 104 and 106, according to an example embodiment of this disclosure. In this example embodiment, the filament of each of the bottom infrared heaters 104 and 106 is preferably made of Fe Cr Al, where Fe represents iron, Cr represents chromium, and Al represents aluminum. The vertical axis of the graph depicts the relative radiant intensity (a.u.) and the horizontal axis depict the wavelength relative to the vertical axis intensity. Curve A represents a first sample of a filament tested and curve B represents a second sample of another filament tested. The curves generally indicate a peak emission at about 2 microns (2000 nm). The first and second sample filaments each drew about 250 watts of power at about 120 volts.

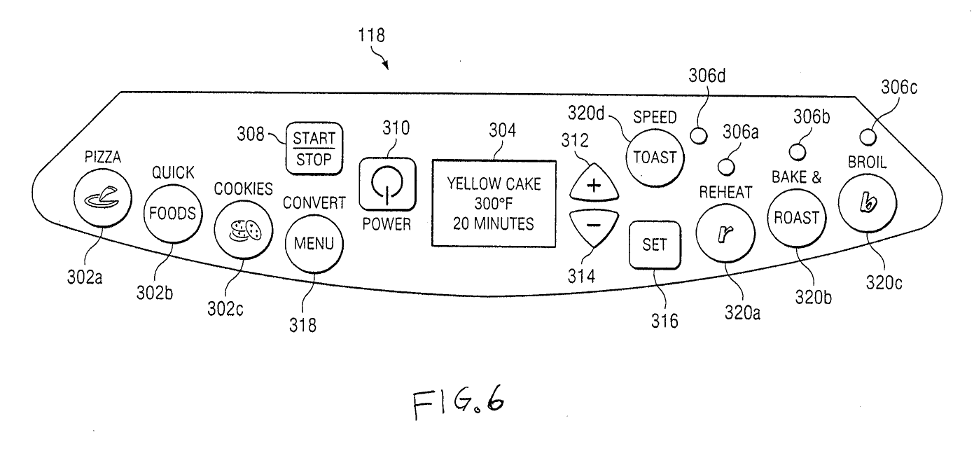

Referring to FIG. 5, depicted is a graph of relative radiant intensity (a.u.) plotted as a function of wavelength of representative filaments that may be used for the top infrared (IR) heater 102, according to an example embodiment of this disclosure. According to this example embodiment, the filament of the top IR heater 102 is preferably made of tungsten. The vertical axis of the graph depicts the relative radiant intensity (a.u.) and the horizontal axis depict the wavelength relative to the vertical axis intensity. Curve C represents a first sample of a tungsten filament tested and curve D represents a second sample of another tungsten filament tested. The curves generally indicate a peak emission at about 1.65 microns (1650 nm). The sample tungsten filaments each drew about 1000 watts of power at about 120 volts.

Referring now to FIG. 6, depicted is a schematic elevational view of an intelligent user interface, according to an example embodiment of this disclosure. The intelligent user interface, generally represented by the numeral 118, may comprise a plurality of control buttons 302, 308, 310, 312, 314 316, 318 and 320, and a display 304. Control buttons 302 may be used for quick selection of cooking profile parameters for popular foods, e.g., pizza 302a, quick foods 302b, cookies 302c, etc. Oven control function buttons 320 may be implemented, e.g., reheat 320a, bake/roast 320b, broil 320c and speed toast 320d. Optionally, lights 306 may be used to indicate which mode the infrared oven is operating in, e.g., reheat 306a, bake/roast 306b, broil 306c, or speed toast 306d. The display 304 also may be used to indicate the cooking mode. Cooking temperature and time may be input by pushing the set button 316, pushing the (+) button 312 to increase the parameter value or pushing the (−) button 314 to decrease the parameter value. The set button 316 also may be used to step through various cooking parameters, e.g., temperature and time that may be indicated on the display 304.

A power on-off button 310 may be used to turn on and off the infrared multi-purpose oven, e.g., oven 100. A start-stop button 308 may be used to start or stop cooking of the food. A menu button 318 may be used to select from a plurality of different foods that may have cooking profiles already defined when using the infrared multi-purpose oven. The menu button 318 may be pressed and a list of foods, indicated on the display 304, and may be scrolled through with the (+) button 312 and the (−) button 314. In addition, the menu button 318 may be used to select a convert menu for determining a cooking profile of a food not on the menu list. The convert menu can may be used to input cooking parameters of standard old technology cooking and convert these parameters into appropriate parameters so that the infrared multi-purpose oven may cook the desired food to the same expected end result.

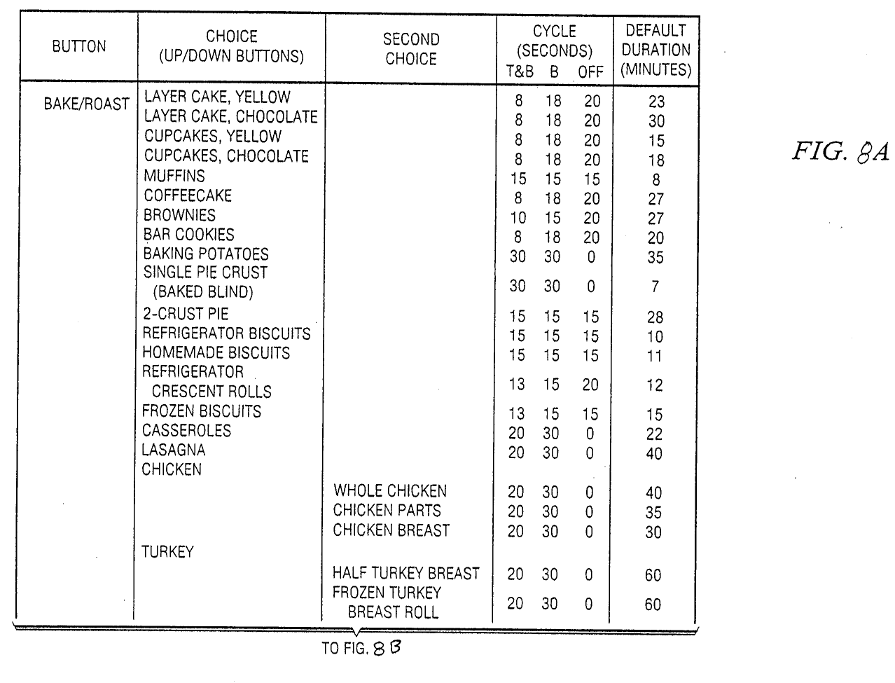

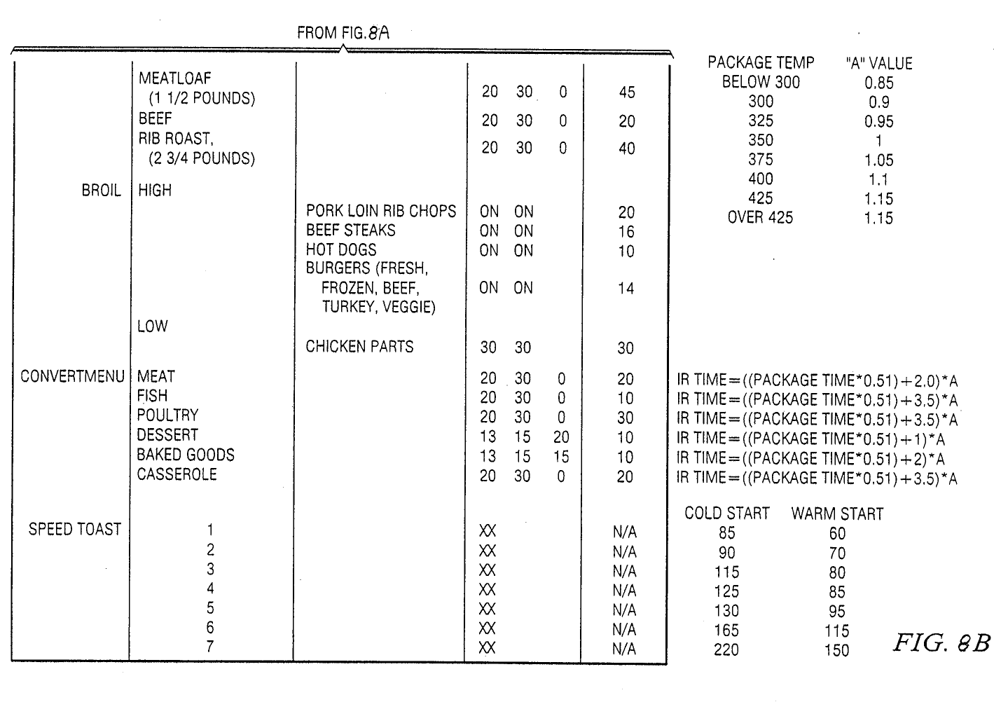

Referring to FIGS. 7, 8A and 8B, depicted are tables of cooking parameters of an intelligent user interface for a multi-purpose oven using infrared heating in the preparation of foods, according to an example embodiment of this disclosure. The button choices depicted in the tables of FIGS. 7, 8A and 8B may be selected through a menu on the display 304, wherein cycle times for the top IR heater 102 and bottom IR heaters 104 and 106 (FIG. 1) and the default duration time in minutes for the heater cycles are programmed as the cooking profile for the selected food to be cooked.

In FIGS. 8A and 8B, the convert menu button may initiate calculation of a cooking profile for the infrared multi-purpose oven by converting standard cooking package times and temperatures to appropriate times and temperatures using the infrared multi-purpose oven for proper cooking of the food. For example: the correct meat cooking time may be converted to the infrared multi-purpose oven cooking time by taking the conventional recommended cooking time, e.g., package time, multiplying by 0.51, adding 2 minutes then adjusting the time by a factor “A” correlated to the conventional recommended cooking temperature. Fish, poultry, deserts, baked goods and casseroles may be converted in a similar fashion as shown in FIG. 7. Speed toasting may be performed for a desired toasting color with time compensation for whether the infrared multi-purpose oven is toasting from a cold or warm start.

While embodiments of this disclosure have been depicted, described, and are defined by reference to example embodiments of the disclosure, such references do not imply a limitation on the disclosure, and no such limitation is to be inferred. The subject matter disclosed is capable of considerable modification, alteration, and equivalents in form and function, as will occur to those ordinarily skilled in the pertinent art and having the benefit of this disclosure. The depicted and described embodiments of this disclosure are examples only, and are not exhaustive of the scope of the disclosure.

What is claimed is:

1-30. (canceled)

31. A cooking apparatus, comprising:
a housing;
a chamber adapted for receiving a food, the chamber located within the housing;
at least one first infrared heater located inside of the chamber and positioned to be on one side of the food;
at least one second infrared heater located inside of the chamber and positioned to be on another side of the food; and
wherein at least one of the at least one first infrared heaters and the at least one second infrared heaters is configured to be repeatedly switched on and off during a plurality of predefined cycles over a duration of time.

32. A cooking apparatus according to claim 31, wherein during each predefined cycle, at least one of the at least one first infrared heaters and the at least one second infrared heaters is switched on during a first period of time and switched off during a second period of time.

33. A cooking apparatus according to claim 32, wherein at least one of the first period of time and the second period of time are determined in accordance with a predefined operating profile associated with the food.

34. A cooking apparatus according to claim 33, wherein the duration of time is determined in accordance with the predefined operating profile associated with the food.

35. A cooking apparatus according to claim 34, wherein:
the duration of time is equal to a default duration plus a user-selectable duration;
the default duration time is determined in accordance with the predefined operating profile associated with the food; and
the user-selectable duration may be a positive duration, a negative duration, or a zero duration.

36. A cooking apparatus according to claim 35, wherein at least one of the first period of time and the second period of time is equal to a default period time determined in accordance with the predefined operating profile associated with the food multiplied by a fraction equal to the duration of time divided by the default duration time.

37. A cooking apparatus according to claim 33, wherein at least one of the first period of time and the second period of time is based at least on the type of food.

38. A cooking apparatus according to claim 33, further comprising an intelligent user interface for controlling the at least one first and the at least one second infrared heaters, wherein:
the intelligent user interface has a plurality of predefined food cooking profiles selectable by a user; and
the predefined operating profile associated with the food is based at least on a food cooking profile selected by the user.

39. A cooking apparatus according to claim 31, wherein the at least one first and the at least one second infrared heaters are configured to emit radiant heat at infrared wavelengths from about 1 to 3 microns for cooking the food.

40. A cooking apparatus according to claim 31, wherein the duration of time is determined by converting a standard cooking package time and a standard cooking package temperature to a calculated duration.

41. A cooking apparatus according to claim 40, wherein the calculated duration is based at least on the type of food.

42. A cooking apparatus according to claim 41, wherein the calculated duration is determined by the equation:
IR TIME=((PACKAGE TIME×B)+C)×A
wherein:
IR TIME is the calculated duration, in minutes;
PACKAGE TIME is the standard cooking package time, in minutes, for cooking the food with a conventional oven;
A is a dimensionless constant based at least on the standard cooking package temperature for cooking the food with a conventional oven;
B is a time constant based at least on the type of food to be prepared; and
C is a dimensionless constant.

43. A method for cooking food, comprising:
locating at least one first infrared heater inside of a chamber and positioned to be on one side of the food;
locating at least one second infrared heater inside of the chamber and positioned to be on another side of the food; and
configuring at least one first infrared heaters and the at least one second infrared heaters to be repeatedly switched on and off during a plurality of predefined cycles over a duration of time.

44. A method according to claim 43, further comprising configuring at least one of the at least one first infrared heaters and the at least one second infrared heaters is switched on during a first period of time and switched off during a second period of time during each predefined cycle.

45. A method according to claim 44, further comprising determining at least one of the first period of time and the second period of time in accordance with a predefined operating profile associated with the food.

46. A method according to claim 45, further comprising determining the duration of time in accordance with the predefined operating profile associated with the food.

47. A method according to claim 46, wherein determining the duration of time comprises setting the duration of time equal to a default duration plus a user-selectable duration; wherein:
the default duration time is determined in accordance with the predefined operating profile associated with the food; and
the user-selectable duration may be a positive duration, a negative duration, or a zero duration.

48. A method according to claim 47, wherein at least one of the first period of time and the second period of time is equal to a default period time determined in accordance with the predefined operating profile associated with the food multiplied by a fraction equal to the duration of time divided by the default duration time.

49. A method according to claim 45, wherein at least one of the first period of time and the second period of time is based at least on the type of food.

50. A method according to claim 43, further comprising configuring the at least one first and the at least one second infrared heaters to emit radiant heat at infrared wavelengths from about 1 to 3 microns for cooking the food.

51. A method according to claim 43, wherein determining the duration of time comprises converting a standard cooking package time and a standard cooking package temperature to a calculated duration.

52. A cooking apparatus according to claim 51, wherein the calculated duration is based at least on the type of food.

53. A cooking apparatus according to claim 52, wherein the calculated duration is determined by the equation:
IR TIME=((PACKAGE TIME×B)+C)×A
wherein:
IR TIME is the calculated duration, in minutes;
PACKAGE TIME is the standard cooking package time, in minutes, for cooking the food with a conventional oven;
A is a dimensionless constant based at least on the standard cooking package temperature for cooking the food with a conventional oven;
B is a time constant based at least on the type of food to be prepared; and
C is a dimensionless constant.
